(19) United States
(12) Patent Application Publication
(10) Pub. No.: US 2011/0226282 A1
(43) Pub. Date: Sep. 22, 2011

(54) CLEANING METHOD USING CLEANING ROBOT

(75) Inventors: Won Seok Choi, Seoul (KR); Se Young Oh, Pohang-si (KR)

(73) Assignee: POSTECH ACADEMY - INDUSTRY FOUNDATION, Pohang-si, Gyeongsangbuk-do (KR)

(21) Appl. No.: 12/672,266

(22) PCT Filed: Aug. 13, 2008
(86) PCT No.: PCT/KR2008/004694

§ 371 Date: Feb. 4, 2010

(30) Foreign Application Priority Data
Aug. 14, 2007 (KR) 10-2007-0081755

(51) Int. Cl. B08B 7/00

(52) U.S. Cl. 134/18; 134/56 R

(57) ABSTRACT

Provided is a cleaning method using a cleaning robot achieving high cleaning efficiency without expensive sensors. The cleaning method using the cleaning robot includes: a first step of traveling and performing a cleaning operation along a path determined by a winding pattern from a cleaning start point by the cleaning robot; a second step of, when the cleaning robot detects an obstacle, traveling and performing the cleaning operation along an outer wall of the obstacle; and a third step of, when the cleaning robot arrives at the path determined by the winding pattern while traveling and performing the cleaning operation along the obstacle, traveling and performing the cleaning operation along the remaining path determined by the winding pattern.

### BACKGROUND OF THE INVENTION

1. Field of the Invention

The present invention relates to a cleaning method using a cleaning robot, and more particularly, to a cleaning method using a cleaning robot achieving high cleaning efficiency without expensive sensors.

2. Description of the Related Art

In general, a cleaning robot is an automatic cleaning machine which automatically scrubs and vacuums dust and dirt from floors while traveling through a district to be cleaned in a predetermined traveling mode. The cleaning robot is constructed with a cleaning unit to suck up dust and dirt and a traveling unit for traveling.

FIG. 1 is a block diagram illustrating the traveling unit of the general cleaning robot.

Referring to FIG. 1, the traveling unit 100 of the cleaning robot mainly includes a detecting unit 110, a controller 120, and a motor driving unit 130.

The detecting unit 110 includes obstacle detection sensors disposed at front, rear, left, and right sides of the cleaning robot to detect a collision with an obstacle or find obstacles before colliding with the obstacles while the cleaning robot travels. The controller 120 controls the traveling operation of the cleaning robot using information obtained by the detecting unit 110. The motor driving unit 130 controls speeds of left and right wheel motors 140 and 141 to enable the cleaning robot to make straight drives, curves, left turns, right turns, and the like, in response to the controller 120.

A cleaning method using the cleaning robot is determined by a traveling mode of the cleaning robot. A general traveling mode of the cleaning robot is a random mode without specific patterns as illustrated in FIG. 2.

FIG. 3 is a flowchart of the cleaning method of the cleaning robot in the random mode.

Referring to FIG. 3, when a cleaning operation is started, the cleaning robot moves forward and performs the cleaning operation until the cleaning robot detects an obstacle (S310). When an obstacle is detected (S320), the cleaning robot stops (S330) and turns in a random direction (S340). When the cleaning is completed, the cleaning robot stops the cleaning operation (S350), and when the cleaning is not completed, the cleaning robot moves forward again and performs the cleaning operation (S310).

The cleaning method of the cleaning robot in the random mode can be implemented at low costs. However, in the random mode, there is a problem in that some spots are repeatedly cleaned but some spots are not cleaned.

In order to solve the aforementioned problem, as illustrated in FIG. 4, traveling modes having predetermined travel patterns are used for the cleaning robot. Among the travel patterns of the cleaning robot illustrated in FIG. 4, FIG. 4a illustrates a spirally-winding travel pattern, FIG. 4b illustrates a polygonally-winding travel pattern, and FIG. 4c illustrates a square-waved travel pattern.

The traveling modes of the cleaning robot having the predetermined travel patterns are used to clean a space without obstacles or to intensively clean a predetermined area. However, the modes have problems in that due to the obstacles or walls, cleaning efficiency is decreased.

Recently, cleaning modes choosing and changing a travel pattern from well-known travel patterns have been used. For a representative example, in a case where the cleaning robot encounters obstacles while traveling and cleaning in a specific travel pattern, the cleaning robot stops or changes the travel pattern to another travel pattern to perform the cleaning operation.

FIG. 5 is a flowchart of a cleaning method of the cleaning robot in a mode combining several travel patterns.

When cleaning is started, a travel pattern for the cleaning robot is determined (S510). Thereafter, the cleaning robot travels and performs the cleaning operation in the determined travel pattern (S520). In a case where obstacles are detected or a predetermined traveling time elapses, it is determined whether or not to continue cleaning in the determined travel pattern (S530). If the cleaning operation is determined not to be performed in the determined travel pattern, it is determined whether the cleaning operation is to be performed in another travel pattern or the cleaning operation is to be terminated by the cleaning robot (S540).

The cleaning methods of the cleaning robot using the mode combining the several travel patterns as described above have problems in that without a localization technology using expensive sensors, as the traveling time of the cleaning robot is increased, errors of a position of the cleaning robot occur, and some spots cannot be cleaned. In addition, the aforementioned cleaning methods of the cleaning robot have a problem in that an optimal mode combining travel patterns is different according to a structure of a room.

FIG. 6 illustrates a wall-following mode used in the cleaning methods of the cleaning robot, and FIG. 7 is a flowchart of a cleaning method using the wall-following mode of the cleaning robot.

In the wall-following mode, as illustrated in FIG. 6, the cleaning robot performs the cleaning operation while traveling along the wall.

The cleaning robot continuously travels along the wall and performs the cleaning operation until obstacles are detected (S710). When the cleaning robot detects obstacles such as a protruding portion (S720), the cleaning robot stops (S730) and turns left or right to follow the obstacle (S740). Thereafter, the cleaning robot follows the obstacles or travels along the wall again to perform the cleaning operation (S750). Here, the cleaning robot calculates a distance from the wall (S760). In a case where the cleaning robot is closer to the wall than a set distance, the cleaning robot turns in such a direction to become more distant from the wall and continues the cleaning operation (S770), and in a case where the cleaning robot is far from the wall than the set distance, the cleaning robot turns in such a direction to approach the wall and continues the cleaning operation (S780). In a condition in which the cleaning robot has to finish the cleaning operation as in a case where a set cleaning time elapses, the cleaning robot finishes the cleaning operation (S790) or travels along the wall to continue the cleaning operation (S750).

However, in the cleaning method of the cleaning robot in the wall-following mode, the cleaning operation is performed only in a cleaning coverage of the cleaning robot from the wall, so that spots farther from the wall than the cleaning coverage cannot be cleaned.

### SUMMARY OF THE INVENTION

The present invention provides a cleaning method of a cleaning robot which performs a cleaning operation in a winding pattern circling from the center to the outside or from the outside to the center and can entirely clean an area to be cleaned while avoiding obstacles when the obstacles are detected.

The present invention also provides a cleaning method of a cleaning robot which performs a cleaning operation along a wall and can entirely clean the surroundings of the wall while repeatedly traveling and performing the cleaning operation in a square-waved pattern.

According to an aspect of the present invention, there is provided a cleaning method using a cleaning robot including: a first step of traveling and performing a cleaning operation along a path determined by a winding pattern from a cleaning start point by the cleaning robot; a second step of, when the cleaning robot detects an obstacle, traveling and performing the cleaning operation along an outer wall of the obstacle; and a third step of, when the cleaning robot arrives at the path determined by the winding pattern while traveling and performing the cleaning operation along the obstacle, traveling and performing the cleaning operation along the remaining path determined by the winding pattern.

According to another aspect of the present invention, there is provided a cleaning method using a cleaning robot including: a first step of traveling and performing a cleaning operation along a wall while maintaining a first interval from the wall; a second step of traveling and performing the cleaning operation in such a direction to become more distant from the wall along a second interval that is longer than the first interval; a third step of traveling and performing the cleaning operation along the wall while maintaining the second interval; and a fourth step of traveling and performing the cleaning operation in such a direction to approach the wall to the first interval.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a traveling unit of a general cleaning robot;

FIG. 2 illustrates a random mode of a cleaning method of a cleaning robot;

FIG. 3 is a flowchart of the cleaning method of the cleaning robot in the random mode;

FIG. 4 illustrates examples of a travel pattern used in a cleaning method of the cleaning robot;

FIG. 5 is a flowchart of a cleaning method of the cleaning robot in a mode combining several travel patterns;

FIG. 6 illustrates a wall-following mode used in the cleaning methods of the cleaning robot;

FIG. 7 is a flowchart of a cleaning method using the wall-following mode of the cleaning robot;

FIG. 8 illustrates embodiments of a cleaning method using a cleaning robot according to the present invention;

FIG. 9 illustrates an example of a flowchart of implementing the cleaning methods using the cleaning robot illustrated in FIG. 8;

FIG. 10 illustrates another embodiment of a cleaning method using the cleaning robot according to the present invention; and

FIG. 11 illustrates an example of a flowchart of traveling and performing the cleaning operation in a square-waved pattern along the wall.

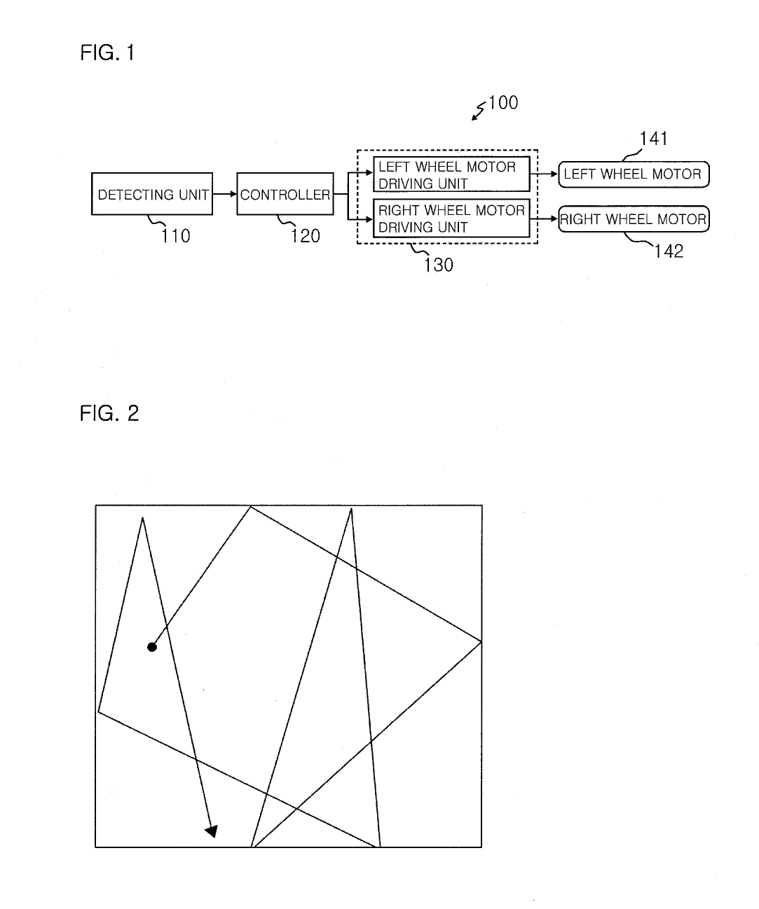

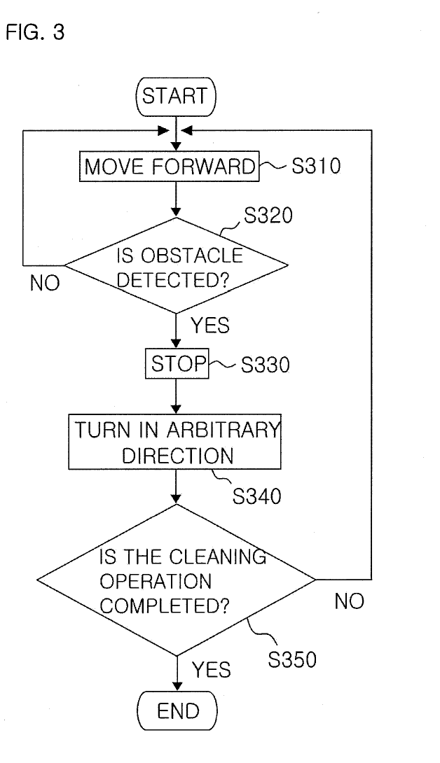

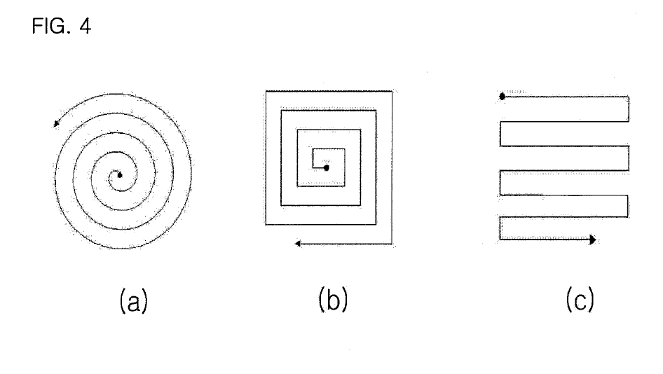

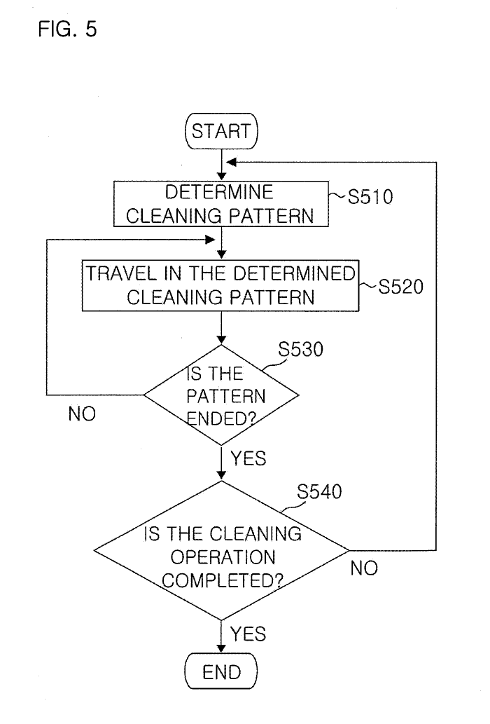

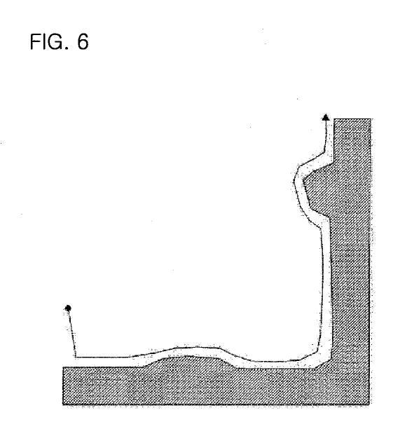

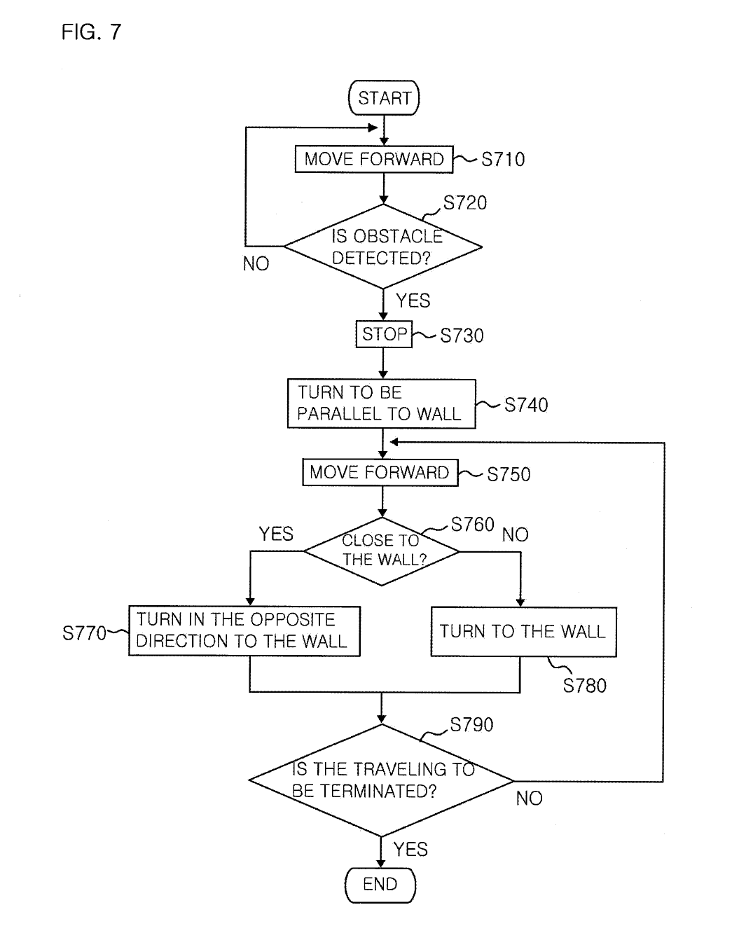

### DETAILED DESCRIPTION OF THE INVENTION

Exemplary embodiments of the present invention will now be described in detail with reference to the accompanying drawings.

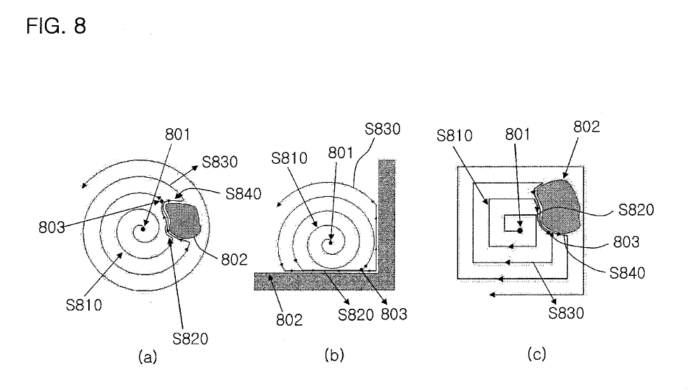

FIG. 8 illustrates embodiments of a cleaning method using a cleaning robot according to the present invention.

Referring to FIGS. 8a, 8b, and 8c, the cleaning method using the cleaning robot includes a first step (S810) of traveling and performing a cleaning operation along a predetermined path, a second step S820 of traveling and performing the cleaning operation in a case where obstacles are detected, and a third step S830 of traveling and performing the cleaning operation along the remaining predetermined path in a case where the cleaning robot passes the obstacles.

A winding pattern may be an application of a wave pattern appearing when a water drop falls to a surface of water in a tub, in which a wave propagates over the entire region of the tub irrespective of a shape of the tub. In addition, the winding pattern may apply a pattern acquired when winding a line around a circular or rectangular axis. In a case where the line is wound around the circular axis, a cross-section thereof may have a spiral shape, and in a case where the line is wound around the rectangular axis, a cross-section thereof may have a polygonal shape.

In a first step S810, the cleaning robot starts cleaning and traveling along a path determined by the winding pattern circling from a cleaning start point 801 to the outside. The path determined by the winding pattern is formed by setting a virtual center of the winding pattern as the cleaning start point 801 by the cleaning robot. Here, in order to minimize spots on which the cleaning operation is not performed and spots that are repeatedly cleaned, the path for cleaning and traveling in the winding pattern may be determined according to a cleaning coverage of the cleaning robot. In addition, the path determined by the winding pattern may also be determined by calculating a distance from the cleaning start point 801 to a farthest point in an area to be cleaned by the cleaning robot. In a case where a current point of the cleaning robot is not the cleaning start point 801, the cleaning robot moves to the cleaning start point 801.

Due to characteristics of the winding pattern circling from the center to the outside, the center point in the area to be cleaned may be determined as the cleaning start point 801. Here, the winding pattern may have a spiral shape as illustrated in FIGS. 8a and 8b or a polygonal shape such as a rectangle or triangle as illustrated in FIG. 8c.

The cleaning robot travels and performs the cleaning operation while detecting obstacles with an obstacle detecting sensor. In a case where the cleaning robot detects an obstacle 802, the cleaning robot performs the second step S820.

In the second step S820, the cleaning robot travels and performs the cleaning operation in the wall-following mode along an outer wall of the obstacle 802. Here, in order to prevent a collision with the obstacle 802, the cleaning robot calculates a distance from the obstacle 802 to travel and perform the clean operation along the outer wall of the obstacle while maintaining a predetermined interval from the outer wall of the obstacle 802.

The cleaning robot may travel and perform the cleaning operation along a relatively closer portion of the outer wall of the obstacle 801 from the cleaning start point 801. Otherwise, the cleaning robot may travel and perform the cleaning operation along a relatively farther portion of the outer wall of the obstacle 801 from the cleaning start point. In a case where the cleaning robot travels and performs the cleaning operation along the relatively farther portion from the cleaning start point 801, due to the third step S830 described later, spots on which the cleaning operation is not performed may exist in the path determined by the winding pattern. Therefore, in order to minimize the spots on which the cleaning operation is not performed in the path determined by the winding pattern, the cleaning robot may travel and perform the cleaning operation along the relatively closer portion of the outer wall of the obstacle 802 from the cleaning start point 801.

In the second step S820, it is determined whether or not the cleaning robot enters the path determined by the winding pattern when the cleaning robot travels and performs the cleaning operation along the outer wall of the obstacle 802. In a case where the cleaning robot arrives at a point 803 positioned on the path determined by the winding pattern while traveling and performing the cleaning operation along the obstacle 802, the third step S830 is performed.

In the third step S830, the cleaning robot travels and performs the cleaning operation along the remaining path determined by the winding pattern. Here, in a case where the point positioned on the path determined by the winding pattern, at which the cleaning robot arrives, is a point that had already been cleaned, the cleaning robot continues traveling and performing the cleaning operation along the obstacle (S840). Therefore, when the cleaning robot arrives at the point 803 on the path determined by the winding pattern while traveling and performing the cleaning operation along the outer surface of the obstacle, repeatedly traveling and performing the cleaning operation on the path that had already been cleaned can be prevented, and the cleaning operation can be performed on the remaining path that is not cleaned yet.

When the cleaning robot completes the traveling and cleaning operation in the path determined by the winding pattern, after the cleaning robot travels round the area to be cleaned along the wall of the area, or after a predetermined cleaning time elapses, the cleaning robot determines whether or not finish the traveling and cleaning operation.

The cleaning robot may calculate a time taken to perform the cleaning operation, a cleaned distance, a cleaned area, a distance from the cleaning start point, and the like by using the cleaning start point and the path determined by the winding pattern on which the cleaning robot travels and performs the cleaning operation. These can be easily calculated by using a rotation history from the cleaning start point to a current point of wheels of the cleaning robot.

In FIG. 8, examples in which the cleaning robot moves from the cleaning start point to the outside of the area are illustrated. However, the opposite case can also be implemented. In the opposite case, the cleaning robot sets an outer point of the winding pattern as the cleaning start point and moves from the cleaning start point to the inside of the area to perform the cleaning operation. Here, the cleaning start point may be a corner portion of the area to be cleaned.

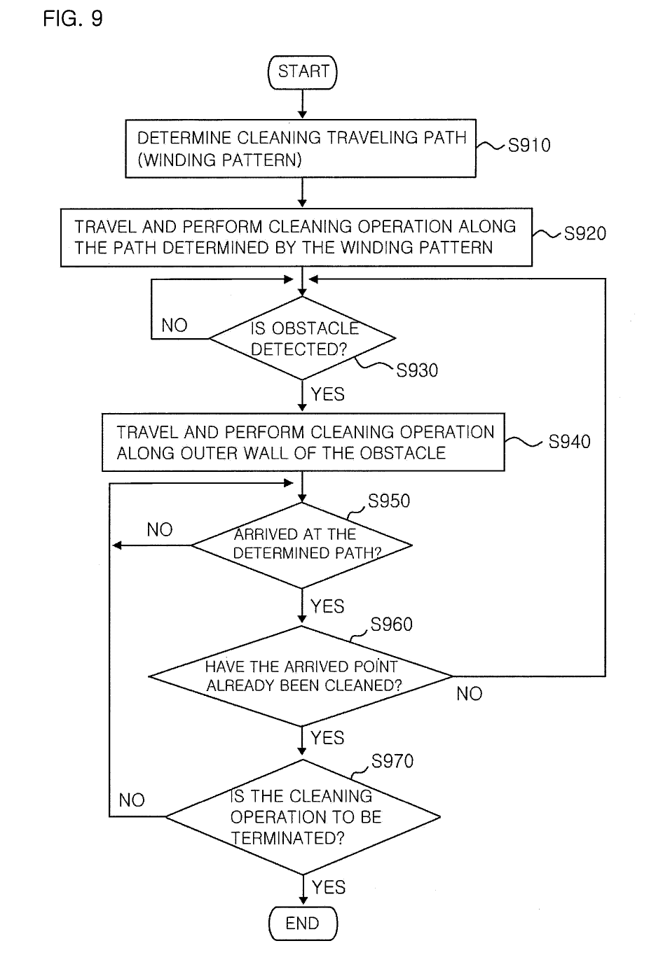

FIG. 9 illustrates an example of a flowchart of implementing the cleaning methods using the cleaning robot illustrated in FIG. 8.

Referring to FIG. 9, first, a path in which the cleaning robot travels and performs the cleaning operation is determined by setting the cleaning start point to a virtual center of the winding pattern (S910). The set virtual center is used to determine a traveling direction from a current point according to the determined winding pattern by the cleaning robot while the cleaning robot travels and performs the cleaning operation and to calculate a termination condition of the traveling and cleaning operation performed along the outer wall of the obstacle.

Thereafter, the cleaning robot starts traveling and performing the cleaning operation along the path determined by the winding pattern. Due to characteristics of the winding pattern, the cleaning robot travels and performs the cleaning operation to surround a path that has been cleaned and increase a cleaned area. Here, the cleaning robot detects obstacles while traveling and performing the cleaning operation (S930).

In a case where obstacles are not detected, the cleaning robot continues traveling and performing the cleaning operation along the path determined by the winding pattern (S920), and in a case where obstacles are detected, the cleaning robot travels and performs the cleaning operation along the outer wall of the obstacle (S940). The cleaning robot determines whether or not a current point is on the path determined by winding pattern while traveling and performing the cleaning operation along the outer wall of the obstacle (S950).

In a case where the current point does not reach the path determined by the winding pattern, the cleaning robot continues traveling and performing the cleaning operation along the outer wall of the obstacle (S940). In a case where the current point reaches the path determined by the winding pattern, it is determined whether or not the current point on the path had already been cleaned (S960). In a case where the position had not been cleaned, the cleaning robot travels and performs the cleaning operation along the remaining path determined by the winding pattern (S920). In a case where the position had already been cleaned, the cleaning robot continues traveling and performing the cleaning operation along the outer wall of the obstacle (S940), or determines whether or not to terminate the traveling and cleaning operation (S970).

In the examples of the cleaning method of the cleaning robot illustrated in FIG. 8, irrespective of a size or a shape of the area to be cleaned, the cleaning robot travels around the start point to gradually increase a cleaned area, avoids obstacles, and returns to the original travel pattern after passing the obstacle, so that the whole area to be cleaned can be entirely cleaned.

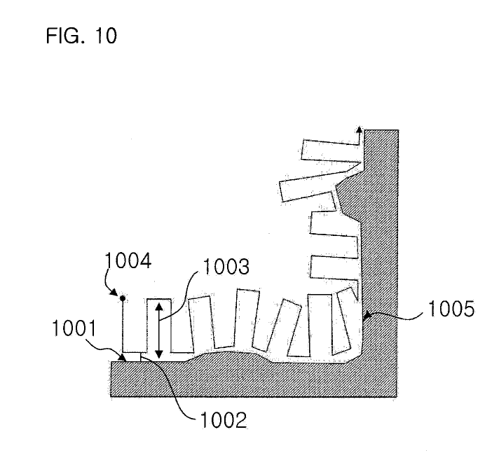

FIG. 10 illustrates another embodiment of the cleaning method using the cleaning robot according to the present invention.

Referring to FIG. 10, the cleaning method using the cleaning robot includes four steps S1010 to S1040 that are sequentially and repeatedly performed by the cleaning robot to enable the cleaning robot to travel and perform the cleaning operation.

In the first step S1010, the cleaning robot travels and performs the cleaning operation along a wall 1001 while maintaining a first interval 1002 from the wall 1001. In the second step S1020, the cleaning robot travels and performs the cleaning operation in such a direction to become more distant from the wall 1001 along a second interval 1003 that is longer than the first interval 1002. In the third step S1030, the cleaning robot travels and performs the cleaning operation along the wall 1001 while maintaining the second interval 1003 from the wall 1001. In the fourth step S1040, the cleaning robot travels and performs the cleaning operation in such a direction to approach the wall 1001 to the first interval 1002.

Here, a transition from a step to the next step is performed by the cleaning robot by turning at a predetermined angle such as 90° from a traveling direction of the current step to a traveling direction of the next step.

A cleaning and traveling distance of the cleaning robot in the second and fourth steps S1020 and S1040 is about a distance obtained by subtracting the first interval 1002 from the second interval 1003. The distance obtained by subtracting the first interval 1002 from the second interval 1003 is a value changed according to a district from the wall which is to be cleaned and may be directly input by a user or determined by the cleaning robot according to a size of the area to be cleaned. A cleaning and traveling distance of the cleaning robot in the first and third steps S1010 and S1030 is determined by a cleaning coverage of the cleaning robot. In order to minimize spots on which the cleaning operation is not performed in the area to be cleaned, the cleaning and traveling distance of the cleaning robot in the first and third steps S1010 and S1030 may be smaller than the cleaning coverage.

The cleaning robot is provided with one or more obstacle detecting sensors at each of front, rear, left, and right sides of the cleaning robot. The obstacle detecting sensors are used to detect an obstacle and calculate a distance from the obstacle. In the first and third steps S1010 and S1030, the obstacle detecting sensors disposed at the left and right sides of the cleaning robot are mainly used, in the second step S1020, the obstacle detecting sensors disposed at the rear side of the cleaning robot are mainly used, and in the fourth step S1040, the obstacle detecting sensors disposed at the front side of the cleaning robot are mainly used.

In a case where the cleaning robot performs the cleaning operation in the second, third, fourth, first, and second steps S1020, S1030, S1040, S1010, and S1020, sequentially, the traveling path is similar to a shape of a square wave. The traveling path in the shape of a square wave along the wall may apply a case in which when a housekeeper moves to wipe the floor, the housekeeper moves in a square-waved pattern in a range of a moving arm with respect to a wall rather than moves from a wall to another wall in a large square-waved pattern.

The cleaning robot repeatedly travels and performs the cleaning operation in the square-waved pattern along the wall. The cleaning is started in one of the first to fourth steps S1010 to S1040. This is described in detail as follows.

In a case where a cleaning start point 1004 is on the first interval 1002, the cleaning robot starts traveling and performing the cleaning operation in the first or second step S1010 or S1020. In a case where the cleaning start point 1004 is on the second interval 1003, the cleaning robot starts traveling and performing the cleaning operation in the third or fourth step S1030 or 1040. In a case where the cleaning start point 1004 is between the first and second intervals 1002 and 1003, the cleaning robot starts traveling and performing the cleaning operation in the second or fourth step S1020 or S1040.

In a case where the cleaning start point 1004 is farther than the second interval 1003, the cleaning robot first travels and performs the cleaning operation in such a direction to approach the wall 1002 to the first or second interval 1002 or 1003. Thereafter, the cleaning robot starts traveling and performing the cleaning operation in one of the first to fourth steps S1010 to S1040.

In a case where the cleaning robot detects that another wall 1005 in addition to the wall 1001 exist within a predetermined distance, the cleaning robot travels and performs the cleaning operation by repeatedly performing the first to fourth steps S1010 to S1040 along the wall 1005.

In a case where the cleaning robot arrives at a point that had already been cleaned like the cleaning start point 1004, it is determined whether or not the traveling and cleaning operation is to be terminated.

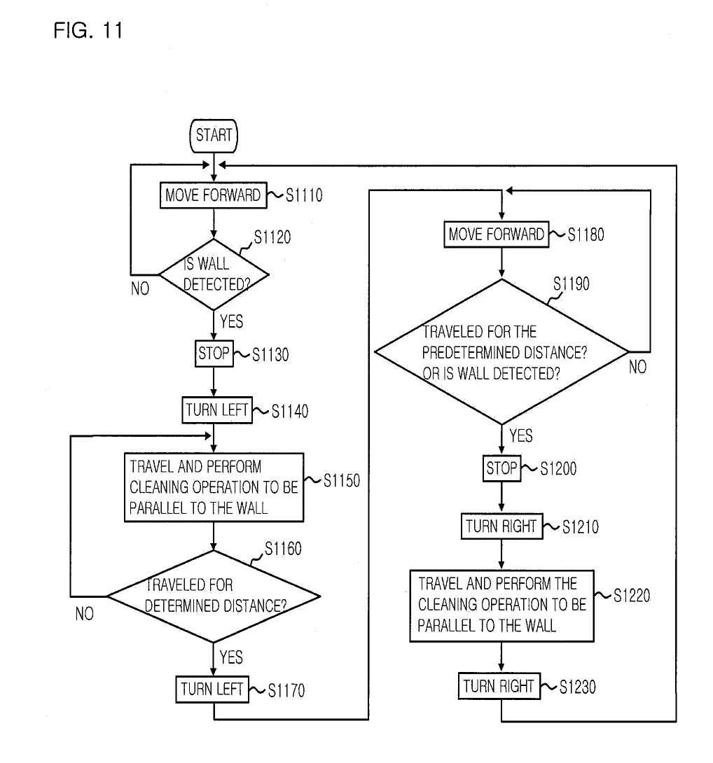

FIG. 11 illustrates an example of a flowchart of traveling and performing the cleaning operation in the square-waved pattern along the wall. Hereinafter, for the convenience of description, it is assumed that the wall is on the right.

First, the cleaning robot travels straight and performs the cleaning operation in such a direction to approach the wall (S1110). Here, the cleaning robot detects whether or not the wall is within a predetermined distance while traveling and performing the cleaning operation (S1120). If the cleaning robot detects a wall, the cleaning robot stops traveling and cleaning (S1130), the cleaning robot turns left to travel in parallel with the wall on the right.

Thereafter, while traveling and performing the cleaning operation in parallel with the wall (S1150), the cleaning robot detects whether or not the traveling and cleaning operation is performed for a predetermined distance, that is, about a cleaning coverage of the cleaning robot (S1160). After the cleaning robot travels and performs the cleaning operation in parallel with the wall for the predetermined distance, the cleaning robot turns left to travel in such a direction to become more distant from the wall (S1170).

Thereafter, the cleaning robot travels straight and performs the cleaning operation in such a direction to become more distant from the wall (S1180). Here, the cleaning robot detects whether or not a wall exists within a predetermined distance or the cleaning robot travels for a predetermined distance (S1190). In a case where a wall exists within the predetermined distance or the cleaning robot moves for the predetermined distance, the cleaning robot stops the traveling and cleaning operation (S1200), and the cleaning robot turns right to travel in parallel with the wall on the right.

Thereafter, the cleaning robot travels and performs the cleaning operation in parallel with the wall (S1220), and after traveling and performing the cleaning operation for a predetermined distance, the cleaning robot turns right to travel in such a direction to approach the wall (S1230). Thereafter, the cleaning robot travels straight and performs the cleaning operation in such a direction to approach the wall (S1110).

Therefore, in the cleaning method of the cleaning robot illustrated in FIG. 9, the cleaning operation is repeatedly performed in the square-waved pattern along the wall, so that cleaning efficiency of the surroundings of the wall with dust can be increased.

In the aforementioned description, the cleaning method using the cleaning robot illustrated in FIG. 8 and the cleaning method using the cleaning robot illustrated in FIG. 10 are separately proposed. However, the two cleaning methods may be simultaneously used to complement each other and further increase the cleaning efficiency. For example, when the center of the area to be cleaned is set to the cleaning start point, the cleaning method illustrated in FIG. 8 is used until the cleaning robot arrives at the surroundings of the wall from the center of the area to be cleaned, and the cleaning method illustrated in FIG. 10 is used near the wall.

Programs for executing the cleaning methods illustrated in FIGS. 8 and 10 can be recorded on a recording medium such as magnetic tapes, magnetic discs, and the like.

In the cleaning method of the cleaning robot according to the present invention, irrespective of a size or a shape of an area to be cleaned, without expensive sensors, the cleaning robot can entirely clean the area to be clean and achieve high cleaning efficiency.

While the present invention has been shown and described in connection with the exemplary embodiments, it will be apparent to those skilled in the art that modifications and variations can be made without departing from the spirit and scope of the invention as defined by the appended claims.

What is claimed is:

1. A cleaning method using a cleaning robot comprising:
a first step of traveling and performing a cleaning operation along a path determined by a winding pattern from a cleaning start point by the cleaning robot;
a second step of, when the cleaning robot detects an obstacle, traveling and performing the cleaning operation along an outer wall of the obstacle; and
a third step of, when the cleaning robot arrives at the path determined by the winding pattern while traveling and performing the cleaning operation along the obstacle, traveling and performing the cleaning operation along the remaining path determined by the winding pattern.

2. The cleaning method of claim 1, wherein in the third step, when the point positioned on the path determined by the winding pattern at which the cleaning robot arrives is a point that had already been cleaned, the cleaning robot continues traveling and performing the cleaning operation along the obstacle.

3. The cleaning method of claim 1, wherein in the second step, the cleaning robot travels and performs the cleaning operation along a relatively closer portion of outer walls of the obstacle from the cleaning start point.

4. The cleaning method of claim 1, wherein in the second step, the cleaning robot travels and performs the cleaning along the outer wall of the obstacles while maintaining a predetermined interval from the outer wall of the obstacle.

5. The cleaning method of claim 1, wherein the cleaning robot sets the cleaning start point to a virtual center of the winding pattern to travel and perform the cleaning operation from the cleaning start point to the outside, or sets the cleaning start point to an outer point of the winding pattern to travel and perform the cleaning operation from the cleaning start point to the inside.

6. The cleaning method of claim 1, wherein the path determined by the winding pattern is determined by a distance from the cleaning start point to the farthest point of an area to be cleaned.

7. The cleaning method of claim 1, wherein the cleaning robot determines whether or not to terminate the traveling and cleaning operation after the traveling and cleaning operation performed along the path determined by the winding pattern is completed.

8. The cleaning method of claim 1, wherein the winding pattern has a spiral shape or a polygonal shape.

9. The cleaning method of claim 1, wherein the cleaning robot calculates one or more of a time taken to perform the cleaning operation, a cleaned distance, a cleaned area, and a distance from the cleaning start point by using a rotation history of wheels of the cleaning robot.

10. A cleaning method using a cleaning robot comprising:
a first step of traveling and performing a cleaning operation along a wall while maintaining a first interval from the wall;
a second step of traveling and performing the cleaning operation in such a direction to become more distant from the wall along a second interval that is longer than the first interval;
a third step of traveling and performing the cleaning operation along the wall while maintaining the second interval; and
a fourth step of traveling and performing the cleaning operation in such a direction to approach the wall to the first interval.

11. The cleaning method of claim 10, wherein the cleaning robot starts in one of the first to fourth steps and travels and performs the cleaning operation by repeatedly performing the first to fourth steps.

12. The cleaning method of claim 10,
wherein, in a case where the cleaning start point is on the first interval, the cleaning robot starts traveling and performing the cleaning operation in the first or second step;
wherein, in a case where the cleaning start point is on the second interval, the cleaning robot starts traveling and performing the cleaning operation in the third or fourth step;
wherein, in a case where the cleaning start point is between the first and second intervals, the cleaning robot starts traveling and performing the cleaning operation in the second or fourth step; and
wherein, in a case where the cleaning start point is farther than the second interval, the cleaning robot first travels and performs the cleaning operation in such a direction to approach the wall to the first or second interval, and starts traveling and performing the cleaning operation in one of the first to fourth steps.

13. The cleaning method of claim 10, wherein, in a case where the cleaning robot detects another wall in addition to the wall, the cleaning robot travels and performs the cleaning operation by repeatedly performing the first to fourth steps along the wall.

14. The cleaning method of claim 10, wherein, in a case where the cleaning robot arrives at a point that had already been cleaned, the cleaning robot determines whether or not to terminate the traveling and cleaning operation.

15. The cleaning method of claim 10, wherein the cleaning robot turns in corresponding traveling directions in the first to fourth steps.

16. A computer-readable medium having embodied thereon a computer program for executing:
a first step of traveling and performing a cleaning operation along a path determined by a winding pattern from a cleaning start point by the cleaning robot;
a second step of, when the cleaning robot detects an obstacle, traveling and performing the cleaning operation along an outer wall of the obstacle; and
a third step of, when the cleaning robot arrives at the path determined by the winding pattern while traveling and performing the cleaning operation along the obstacle, traveling and performing the cleaning operation along the remaining path determined by the winding pattern.

17. A computer-readable medium having embodied thereon a computer program for executing:
a first step of traveling and performing a cleaning operation along a wall while maintaining a first interval from the wall;
a second step of traveling and performing the cleaning operation in such a direction to become more distant from the wall along a second interval that is longer than the first interval;
a third step of traveling and performing the cleaning operation along the wall while maintaining the second interval; and
a fourth step of traveling and performing the cleaning operation in such a direction to approach the wall to the first interval.
